(19) United States
(12) Patent Application Publication
(10) Pub. No.: US 2015/0130729 A1
(43) Pub. Date: May 14, 2015

(54) DISPLAY DEVICE

(71) Applicants: Keisuke Kobayashi, Tokyo (JP); Mitsuo Shimotani, Tokyo (JP); Masakazu Shoji, Tokyo (JP); Yuji Nobe, Tokyo (JP); Hiroki Fujisawa, Tokyo (JP)

(72) Inventors: Keisuke Kobayashi, Tokyo (JP); Mitsuo Shimotani, Tokyo (JP); Masakazu Shoji, Tokyo (JP); Yuji Nobe, Tokyo (JP); Hiroki Fujisawa, Tokyo (JP)

(73) Assignee: Mitsubishi Electric Corporation, Tokyo (JP)

(21) Appl. No.: 14/398,661

(22) PCT Filed: Jul. 19, 2012
(86) PCT No.: PCT/JP2012/068350

§ 371 Date: Nov. 3, 2014

(51) Int. Cl. G06F 3/041

(52) U.S. Cl. CPC G06F 3/0418
USPC 345/173

(57) ABSTRACT

A display device includes a liquid crystal display panel 5, a touch panel 3 that is disposed on a display surface side of the liquid crystal display panel 5 and that has a touch operation area wider than a display area of the above-mentioned liquid crystal display panel 5, and a guard 4 or 4a that is disposed between an area 3a included in the touch operation area and corresponding to the display area, and an area 3b included in the touch operation area and corresponding to an outside of the display area, and that physically restricts an operation object which performs an operation on the above-mentioned touch operation area from moving between the areas.

### FIELD OF THE INVENTION

The present invention relates to a display device equipped with a touch panel.

### BACKGROUND OF THE INVENTION

While a touch panel can accept various operating methods and can present various operation items which can be operated, there is a high possibility that the user performs an incorrect operation.

For example, the user may erroneously touch another adjacent icon with a finger with which he or she has been performing a scroll operation because the touch operation is performed on the same touch surface.

Conventionally, a technique of disposing a touch ineffective area in a peripheral portion of a desired operation area on the touch operation area in order to prevent an incorrect operation as mentioned above has been proposed (for example, refer to patent references 1 and 2).

### RELATED ART DOCUMENT

### Patent Reference

Patent reference 1: Japanese Unexamined Patent Application Publication No. Hei 2-112013
Patent reference 2: Japanese Unexamined Patent Application Publication No. Hei 9-325859

### SUMMARY OF THE INVENTION

### Problems to be Solved by the Invention

A problem with the conventional technique is that because the touch ineffective area which does not accept any operation which can result in an incorrect operation, and the area which accepts a touch operation are disposed in the same touch surface, there is a high possibility that an operation object which has been performing an operation along the touch surface crosses the touch ineffective area, and incorrect operations cannot be sufficiently prevented.

In recent years, not only the touch operation area superimposed on the display area but also a portion outside the display area are used for operations. For example, there is provided a display device in which a touch operation area is made to be wider than a display area, and an operation member which accepts a specific operation is formed in an area included in the touch operation area and corresponding to an outside of the display area.

In a case in which in the above-mentioned display device operation members are disposed in the area corresponding to the display area in which various operation items are displayed, and operation members are disposed in the area corresponding to the outside of the display area in which specific operation items are presented fixedly, there is a high possibility that for example, the user performs an incorrect operation of moving a finger with which he or she has been performing a scroll operation in the display area to outside the display area.

The present invention is made in order to solve the above-mentioned problem, and it is therefore an object of the present invention to provide a display device that can reduce incorrect operations on a touch panel.

### Means for Solving the Problem

In accordance with the present invention, there is provided a display device including: a display; a touch panel that is disposed on a display surface side of the display and that has a touch operation area wider than a display area of the above-mentioned display; and a guard that is disposed between an area included in the touch operation area and corresponding to the display area, and an area included in the touch operation area and corresponding to an outside of the display area, and that physically restricts an operation object which performs an operation on the above-mentioned touch operation area from moving between the areas.

### Advantages of the Invention

In accordance with the present invention, there is provided an advantage of being able to reduce incorrect operations on the touch panel.

### BRIEF DESCRIPTION OF THE FIGURES

FIG. 1 is a view showing a display device in accordance with Embodiment 1 of the present invention;

FIG. 2 is a view showing another example of the display device in accordance with Embodiment 1;

FIG. 3 is a view showing an example of the structure of a periphery of a touch panel in the display device of FIG. 2;

FIG. 4 is a view showing a display device in accordance with Embodiment 2 of the present invention;

FIG. 5 is a view showing another example of the display device in accordance with Embodiment 2; and

FIG. 6 is a view showing a display device in accordance with Embodiment 3 of the present invention.

### EMBODIMENTS OF THE INVENTION

Hereafter, in order to explain this invention in greater detail, the preferred embodiments of the present invention will be described with reference to the accompanying drawings.

### Embodiment 1

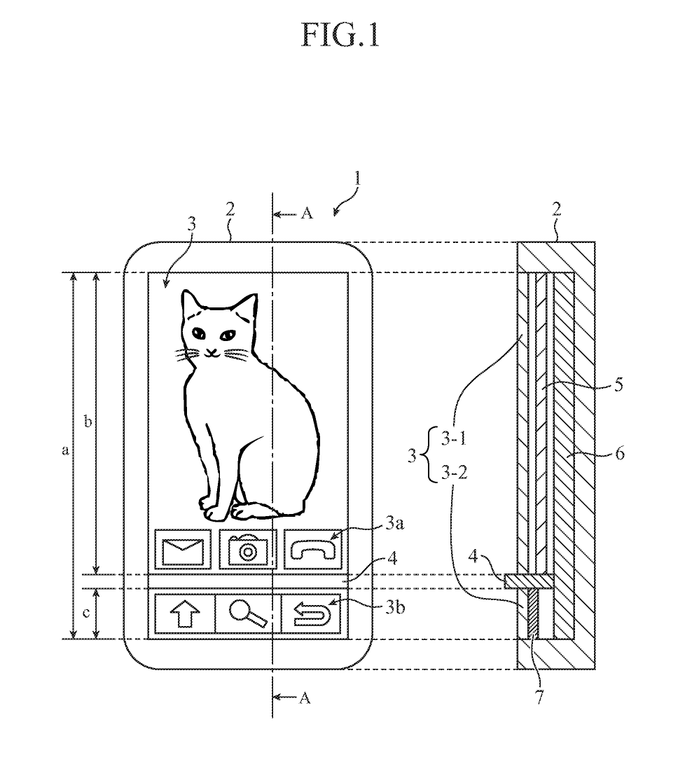

FIG. 1 is a view showing a display device in accordance with Embodiment 1 of the present invention. On a left side of the figure, a front view of the display device 1 is shown, and on a right side of the figure, a cross-sectional view indicated by arrows and schematically showing a cross section taken along the A-A line is shown.

The display device 1 in accordance with Embodiment 1 is applied to, for example, information processing equipment, such as a smart phone, a tablet PC, or a PND (Portable Navigation Device). A housing case 2 of the display device 1 is a box-shaped one whose image display surface side in which a touch panel 3 is incorporated is opened, as shown in FIG. 1, and accommodates a liquid crystal display panel 5 and an internal circuit 6 therein.

The touch panel 3 has a structure in which, for example, two transparent electrode sheets are laminated via a spacing member therebetween, and is constructed in such a way that when the upper and lower transparent electrodes are locally brought into contact with each other by a push performed by an operation object, such as a finger, the coordinates of the pushed position are detected.

In the display device 1, a touch operation area of the touch panel 3 (having a longitudinal size of a) is wider than a display area, and an operation area 3a (having a longitudinal size of b) corresponding to the display area and an area 3b (having a longitudinal size of c) corresponding to an outside of the display area are formed, as shown in FIG. 1.

Between the areas 3a and 3b, a guard 4 formed of a resin molded part or the like is disposed. The guard 4 is a partition wall projecting from the touch panel surface, as shown in the cross section of FIG. 1, and physically restricts an operation object which performs an operation on the touch operation area from moving between the areas 3a and 3b.

For example, even if a finger which is performing an operation in the area 3a moves toward the area 3b erroneously, the finger is restricted from moving to the area 3b because the finger collides with the guard 4. As a result, incorrect operations on the touch panel 3 can be reduced.

In the area 3a corresponding to the display area, icon images or button images showing descriptions of operations (in the example of FIG. 1, an e-mail icon, a camera icon, and a phone icon) are displayed in the display area of the liquid crystal display panel 5. When one of these icon images or button images is operated by an operation object, the process according to the description is performed.

On a rear surface of the area 3b corresponding to the outside of the display area, a printed member 7 on which a non-transparent print is produced is formed as shown in the cross section of FIG. 1. In the printed member 7, the non-transparent print of a portion corresponding to each of symbols or characters showing descriptions of operations in the area 3b is removed, or after the non-transparent print of the portion corresponding to each of the symbols or characters is removed, a transparent print is produced. The portion corresponding to each of the symbols or characters showing the descriptions of the operations allows light from a light source placed on a rear surface side of the touch panel 3 to pass therethrough, so that the portion is illuminated.

In the example shown in FIG. 1, the guard 4 physically partitions the touch panel 3.

More specifically, the touch panel 3 is partitioned into a touch panel portion 3-1 corresponding to the area 3a, and a touch panel portion 3-2 corresponding to the area 3b via the guard 4.

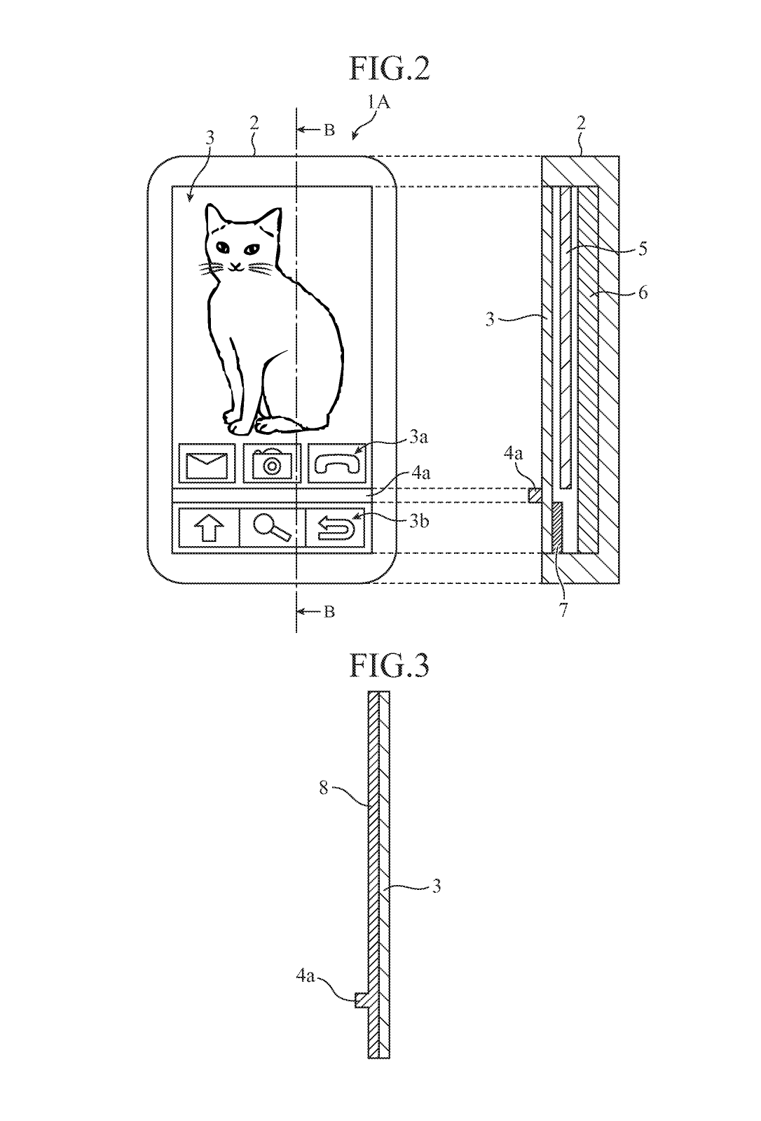

FIG. 2 is a view showing another example of the display device in accordance with Embodiment 1. On a left side of the figure, a front view of the display device 1A is shown, and on a right side of the figure, a cross-sectional view indicated by arrows and schematically showing a cross section taken along the B-B line is shown.

In the display device 1A shown in FIG. 2, a guard 4a that physically restricts an operation object which performs an operation on the touch operation area from moving between the areas 3a and 3b, and that is a partition wall is disposed, like in the case of the structure of FIG. 1. However, the guard 4a is disposed on the touch panel surface of the touch panel 3, as shown in the cross section of FIG. 2, and does not partition the touch panel 3.

By constructing the display device this way, it can be made to have a simpler structure. For example, as shown in FIG. 3, the display device 1A can be implemented by sticking a cover 8 on which the guard 4a is formed on the touch panel surface.

The guard 4 or 4a can be made from a rubber-like material. In this case, an operation object such as a finger is restricted from moving between the areas 3a and 3b by virtue of a so-called frictional contact which comes into contact with the guard 4 or 4a with a frictional force higher than that on the touch panel surface. As a result, movements of the operation object can be restricted more exactly.

Further, the guard 4 or 4a can be made to be transparent or semi-transparent. By constructing the guard this way, it can be assimilated into the design of the display surface side of the display device 1 or 1A.

In addition, by making the guard 4 or 4a have either the same design as a peripheral portion of the touch panel 3 or a color or a pattern similar to that of the peripheral portion of the touch panel, or making the guard have either the same color and pattern as the peripheral portion of the touch panel or a color and a pattern similar to those of the peripheral portion of the touch panel, the guard can be assimilated into the design of the display surface side of the display device 1 or 1A.

The display device 1 or 1A can be constructed in such a way that the types of operational inputs which one of the areas 3a and 3b can accept are limited as compared with those of operational inputs which the other area can accept. By constructing the display device this way, for each area, the user should just perform an operational input of a type corresponding to the area, the convenience of operations can be improved.

Particularly, by making the types of operational inputs which the area 3a can accept differ from those of operational inputs which the area 3b can accept, the convenience of operations can be further improved.

The types of operational input are provided for the touch operation area. For example, the types of operational input include a touch operational input and a gesture operational input.

The touch operational input includes, for example, a tap, a double-tap, and a flick. A tap is an operation of hitting the touch panel surface once with a finger, and a double-tap is an operation of hitting the touch panel surface twice. Further, a flick is an operation of flicking a finger on the touch panel surface.

The gesture operational input includes, for example, a drug, a pinch-in, a pinch-out, and a handwriting gesture. The drug is an operation of sliding a finger without lifting the finger from the touch panel surface, and is used for a scroll of a map display, etc. The pinch-in is an operation of closing two open fingers without lifting the fingers from the touch panel surface. On the contrary, the pinch-out is an operation of opening two closed fingers without lifting the fingers from the touch panel surface. These operations are used for enlargement, reduction, and so on of a map display. The handwriting gesture is an operation of tracing a character or the like on the touch panel surface with a finger to make a device recognize the character or the like.

Further, the types of operational inputs which the area 3b corresponding to the outside of the display area can accept are further limited as compared with those of operational inputs which the area 3a corresponding to the display area can accept. For example, the display device is constructed in such a way that the area 3a accepts at least a gesture operational input made by an operation object, while the area 3b corresponding to the outside of the display area accepts a touch operational input made by an operation object.

By constructing the display device this way, it is constructed in such a way that the area 3b corresponding to the outside of the display area can accept a simple operation, while the area 3a corresponding to the display area also accepts a complicated operation.

For example, by assigning operations regarding specific basic processes to the area 3b, these can be performed through a simple operation.

As mentioned above, the display device in accordance with this Embodiment 1 includes the liquid crystal display panel 5, the touch panel 3 that is disposed on a display surface side of the liquid crystal display panel 5 and that has a touch operation area wider than the display area of the above-mentioned liquid crystal display panel 5, and the guard 4 or 4a that is disposed between the area 3a included in the touch operation area and corresponding to the display area, and the area 3b included in the touch operation area and corresponding to an outside of the display area, and that physically restricts an operation object which performs an operation on the above-mentioned touch operation area from moving between the areas.

By constructing the display device this way, an operation object which has been performing an operation in the area 3a is restricted from erroneously moving toward the area 3b. Therefore, incorrect operations on the touch panel 3 can be reduced.

Further, because in accordance with this Embodiment 1 the guard 4 or 4a is a partition wall projecting from the touch panel surface, movements of an operation object between the areas 3a and 3b can be restricted exactly. As a result, incorrect operations on the touch panel 3 can be reduced.

In addition, because in accordance with this Embodiment 1 the guard 4 or 4a is made from a rubber-like material, movements of an operation object can be restricted more exactly.

Further, because in accordance with this Embodiment 1 the guard 4 or 4a is transparent or semi-transparent, the guard can be assimilated into the design of the display surface side of the display device 1 or 1A.

In addition, because in accordance with this Embodiment 1 the guard 4 or 4a has either the same design as a peripheral portion of the touch panel 3 or a color or a pattern similar to that of the peripheral portion of the touch panel, or has both a color and a pattern similar to those of the peripheral portion of the touch panel, the guard can be assimilated into the design of the display surface side of the display device 1 or 1A.

Further, because in accordance with this Embodiment 1 the types of operational inputs which one of the area 3a included in the touch operation area and corresponding to the display area and the area 3b included in the touch operation area and corresponding to the outside of the display area can accept are limited as compared with those of operational inputs which the other area can accept, or the types of operational inputs which one of the areas can accept are different from those of operation inputs which the other area can accept, for each area, the user should just perform an operational input of a type corresponding to the area, and therefore the convenience of operations can be improved.

In addition, because in accordance with this Embodiment 1 the types of operational inputs which the area 3b included in the touch operation area and corresponding to the outside of the display area can accept are further limited as compared with those of operational inputs which the area 3a corresponding to the display area can accept, the convenience of operations can be improved.

Further, because in accordance with this Embodiment 1 the area 3a included in the touch operation area and corresponding to the display area accepts at least a gesture operational input made by an operation object, while the area 3b corresponding to the outside of the display area accepts a touch operational input made by an operation object, the convenience of operations can be improved.

### Embodiment 2

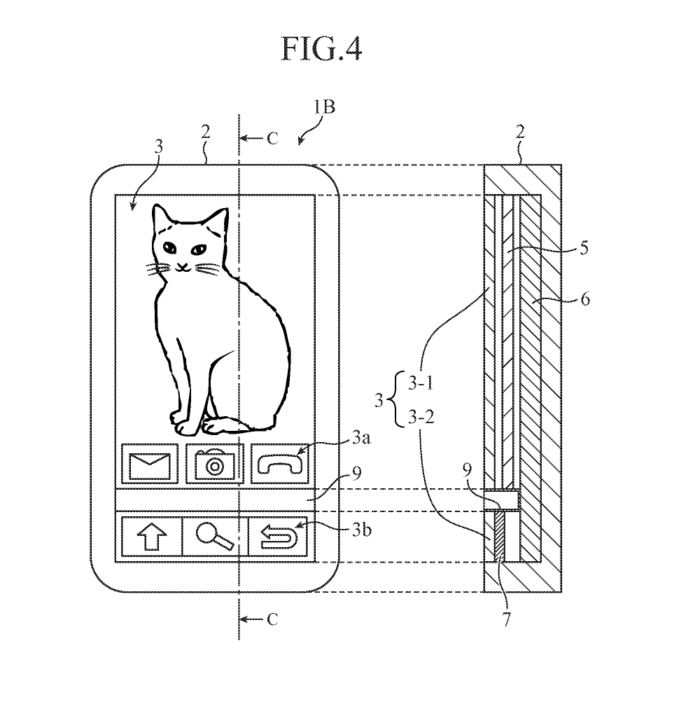

FIG. 4 is a view showing a display device in accordance with Embodiment 2. On a left side of the figure, a front view of the display device 1B is shown, and on a right side of the figure, a cross-sectional view indicated by arrows and schematically showing a cross section taken along the C-C line is shown.

In the display device 1B shown in FIG. 4, a guard 9 which is a partition groove recessed from a touch panel surface toward a rear surface side is disposed.

The guard 9 partitions the touch panel 3 physically. More specifically, the touch panel 3 is partitioned into a touch panel portion 3-1 corresponding to an area 3a and a touch panel portion 3-2 corresponding to an area 3b via the guard 9.

Also this guard 9 physically restricts an operation object which performs an operation on a touch operation area from moving between the areas 3a and 3b. For example, even if a finger which is performing an operation in the area 3a moves toward the area 3b erroneously, the finger is fitted into the guard 9 and is restricted from moving to the area 3b. As a result, incorrect operations on the touch panel 3 can be reduced.

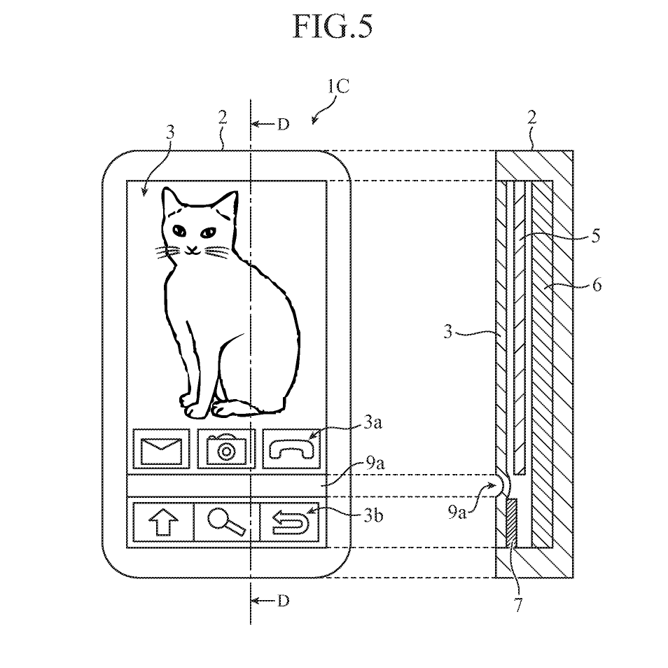

FIG. 5 is a view showing another example of the display device in accordance with Embodiment 2. On a left side of the figure, a front view of the display device 1C is shown, and on a right side of the figure, a cross-sectional view indicated by arrows and schematically showing a cross section taken along the D-D line is shown.

In the display device 1C shown in FIG. 5, a guard 9a which is a partition groove that physically restricts an operation object which performs an operation on the touch operation area from moving between the areas 3a and 3b is disposed, like in the case of the structure of FIG. 4. However, the guard 9a is constructed of a recess of the touch panel 3 itself, as shown in the cross section of FIG. 5, and does not partition the touch panel 3. By constructing the display device this way, it can be made to have a simpler structure.

Also each of the display devices 1B and 1C can be constructed in such a way that the types of operational inputs which one of the areas 3a and 3b can accept are limited as compared with those of operational inputs which the other area can accept. By constructing the display device this way, for each area, the user should just perform an operational input of a type corresponding to the area, the convenience of operations can be improved.

Particularly, by making the types of operational inputs which the area 3a can accept differ from those of operational inputs which the area 3b can accept, the convenience of operations can be further improved.

Further, also each of the display devices 1B and 1C can be constructed in such a way that the types of operational inputs which the area 3b corresponding to the outside of the display area can accept are further limited as compared with those of operational inputs which the area 3a corresponding to the display area can accept.

For example, the display device is constructed in such a way that the area 3a accepts at least a gesture operational input made by an operation object, while the area 3b corresponding to the outside of the display area accepts a touch operational input made by an operation object. By constructing the display device this way, it is constructed in such a way that the area 3b corresponding to the outside of the display area can accept a simple operation, while the area 3a corresponding to the display area also accepts a complicated operation.

For example, by assigning operations regarding specific basic processes to the area 3b, any one of these processes can be performed through a simple operation.

As mentioned above, because in accordance with this Embodiment 2 the guard 9 or 9a is a partition groove recessed from the touch panel surface toward the rear surface side, the same advantages as those provided by above-mentioned Embodiment 1 can be provided.

### Embodiment 3

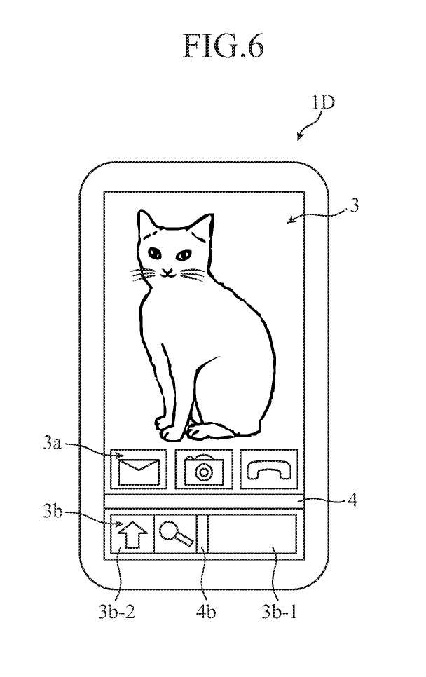

FIG. 6 is a view showing a display device in accordance with Embodiment 3 of the present invention. In the display device 1D shown in FIG. 6, an area 3b corresponding to an outside of a display area is partitioned into a first area 3b-1 and a second area 3b-2, and a guard 4b is disposed between the areas 3b-1 and 3b-2. In the example shown in FIG. 6, a guard 4 is disposed also between the areas 3a and 3b, like that in accordance with above-mentioned Embodiment 1.

The guard 4b is a partition wall which physically restricts an operation object, such as a finger, from moving between the areas 3b-1 and 3b-2.

For example, even if a finger which is performing an operation in the area 3b-1 moves toward the area 3b-2 erroneously, the finger is restricted from moving to the area 3b-2 because the finger collides with the guard 4b. As a result, incorrect operations on the touch panel 3 can be reduced.

As an alternative, the guard 4b can be constructed as a partition groove, like that in accordance with above-mentioned Embodiment 2.

Even in the case in which the guard is constructed this way, movements of an operation object between the areas 3b-1 and 3b-2 can be physically restricted. For example, even if a finger which is performing an operation in the area 3b-1 moves toward the area 3b-2 erroneously, the finger is fitted into the guard 4b and is restricted from moving to the area 3b-2.

The types of operational inputs which the area 3b-1 can accept can be made to differ from those of operational inputs which the area 3b-2 can accept. For example, the first area 3b-1 accepts a gesture operational input, while the second area 3b-2 accepts a touch operational input. By constructing the display device this way, for each of the areas 3b-1 and 3b-2, the user should just perform an operation corresponding to the area, and therefore the convenience of operations can be improved.

The types of operational inputs which the first and second areas 3b-1 and 3b-2 can accept are further limited as compared with those of operational inputs which the area 3a corresponding to the display area can accept. By constructing the display device this way, for each area, the user should just perform an operational input of a type corresponding to the area, the convenience of operations can be improved.

Particularly, by making the types of operational inputs which the first and second areas 3b-1 and 3b-2 can accept differ from those of operational inputs which the area 3a can accept, the convenience of operations can be further improved.

As mentioned above, because in accordance with this Embodiment 3 the area 3b corresponding to the outside of the display area is partitioned into the first area 3b-1 and the second area 3b-2, and the guard 4b is further disposed between the first area 3b-1 and the second area 3b-2 to physically restrict an operation object from moving between the areas, incorrect operations in the area 3b corresponding to the outside of the display area can be reduced.

Further, because in accordance with this Embodiment 3 the types of operational inputs which the first area 3b-1 in the area 3b corresponding to the outside of the display area can accept are different from those of operation inputs which the second area 3b-2 can accept, for each of the first and second areas 3b-1 and 3b-2, the user should just perform an operation corresponding to the area, and therefore the convenience of operations can be improved.

In addition, because the first area 3b-1 accepts a gesture operational input, while the second area 3b-2 accepts a touch operational input, the convenience of operations can be improved.

Further, because in accordance with this Embodiment 3 the types of operational inputs which the first and second areas 3b-1 and 3b-2 in the area 3b corresponding to the outside of the display area can accept are further limited as compared with those of operational inputs which the area 3a corresponding to the display area can accept, the convenience of operations can be improved.

In addition, because in accordance with this Embodiment 3 the types of operational inputs which the first and second areas 3b-1 and 3b-2 in the area 3b corresponding to the outside of the display area can accept are different from those of operation inputs which the area 3a corresponding to the display area can accept, the convenience of operations can be improved.

While the present invention has been described in its preferred embodiments, it is to be understood that an arbitrary combination of two or more of the above-mentioned embodiments can be made, various changes can be made in an arbitrary component in accordance with any one of the above-mentioned embodiments, and an arbitrary component in accordance with any one of the above-mentioned embodiments can be omitted within the scope of the invention.

### INDUSTRIAL APPLICABILITY

Because the display device in accordance with the present invention can reduce incorrect operations on the touch panel, the display device is suitable for use as a display device of a vehicle-mounted information device which is placed in an environment where the user cannot concentrate on an operation, such as a situation in which the user is driving.

### EXPLANATIONS OF REFERENCE NUMERALS

1, 1A to 1D display device, 2 housing case, 3 touch panel, 3-1 and 3-2 touch panel portion, 3a area corresponding to display area, 3b area corresponding to outside of display area, 3b-1 first area, 3b-2 second area, 4, 4a, 4b, 9, and 9a guard, 4 liquid crystal display panel, 5 internal circuit, 6 printed member, 8 cover.

1-14. (canceled)

15. A display device comprising:
a display;
a touch panel that is disposed on a display surface side of said display and that has a touch operation area wider than a display area of said display; and
a guard that is disposed between an area included in said touch operation area and corresponding to said display area, and an area included in said touch operation area and corresponding to an outside of said display area, and that physically restricts an operation object which performs an operation on said touch operation area from moving between the areas, wherein
the area corresponding to the outside of said display area is partitioned into a first area and a second area, said guard is further disposed between said first area and said second area to physically restrict said operation object from moving between the areas, and types of operational inputs which said first area in the area corresponding to the outside of said display area can accept are different from those of operational inputs which said second area can accept.

16. The display device according to claim 15, wherein said first area accepts a gesture operational input, and said second area accepts a touch operated input.

17. The display device according to claim 15, wherein types of operational inputs which said first area and said second area in the area corresponding to the outside of said display area can accept are further limited as compared with those of operational inputs which the area corresponding to said display area can accept.

18. The display device according to claim 15, wherein types of operational inputs which said first area and said second area in the area corresponding to the outside of said display area can accept are different from those of operational inputs which the area corresponding to said display area can accept.

19. The display device according to claim 15, wherein said guard is a partition wall projecting from a touch panel surface.

20. The display device according to claim 15, wherein said guard is a partition groove which is recessed from a touch panel surface toward a rear surface side.

21. The display device according to claim 15, wherein said guard is made from a rubber-like material.

22. The display device according to claim 15, wherein said guard is transparent or semi-transparent.

23. The display device according to claim 15, wherein said guard has the same design as a peripheral portion of the touch panel, a color or a pattern similar to that of the peripheral portion of the touch panel, or both a color and a pattern similar to those of the peripheral portion of the touch panel.

24. The display device according to claim 15, wherein types of operational inputs which one of the area included in said touch operation area and corresponding to said display area and the area included in said touch operation area and corresponding to the outside of said display area can accept are limited as compared with those of operational inputs which the other area can accept, or types of operational inputs which one of the areas can accept are different from those of operation inputs which the other area can accept.

25. The display device according to claim 24, wherein the types of operational inputs which the area included in said touch operation area and corresponding to the outside of said display area can accept are further limited as compared with those of operational inputs which the area corresponding to said display area can accept.

26. The display device according to claim 25, wherein the area included in said touch operation area and corresponding to said display area accepts at least a gesture operational input made by said operation object, and the area corresponding to the outside of said display area accepts a touch operational input made by said operation object.

27. A display device comprising:
a display;
a touch panel that is disposed on a display surface side of said display and that has a touch operation area wider than a display area of said display; and
a guard that is disposed between an area included in said touch operation area and corresponding to said display area, and an area included in said touch operation area and corresponding to an outside of said display area, and that physically restricts an operation object which performs an operation on said touch operation area from moving between the areas, wherein
the area corresponding to the outside of said display area is partitioned into a first area and a second area, said guard is further disposed between said first area and said second area to physically restrict said operation object from moving between the areas, and types of operational inputs which said first area and said second area in the area corresponding to the outside of said display area can accept are further limited as compared with those of operational inputs which the area corresponding to said display area can accept.

28. The display device according to claim 27, wherein said guard is a partition wall projecting from a touch panel surface.

29. The display device according to claim 27, wherein said guard is a partition groove which is recessed from a touch panel surface toward a rear surface side.

30. The display device according to claim 27, wherein said guard is made from a rubber-like material.

31. The display device according to claim 27, wherein said guard is transparent or semi-transparent.

32. The display device according to claim 27, wherein said guard has the same design as a peripheral portion of the touch panel, a color or a pattern similar to that of the peripheral portion of the touch panel, or both a color and a pattern similar to those of the peripheral portion of the touch panel.
